(19) United States
(12) Patent Application Publication
(10) Pub. No.: US 2018/0056650 A1
(43) Pub. Date: Mar. 1, 2018

(54) METHOD FOR CONTROLLING ACTUATORS OF AN INK PRINTING SYSTEM

(71) Applicant: Océ Holding B.V., Venlo (NL)

(72) Inventors: Wolfgang Hettler, Feldkirchen (DE); Christian Maier, Feldkirchen (DE)

(73) Assignee: Océ Holding B.V., Venlo (NL)

(21) Appl. No.: 15/690,806

(22) Filed: Aug. 30, 2017

(30) Foreign Application Priority Data
Aug. 31, 2016 (DE) 102016116195.0

(51) Int. Cl. B41J 2/045

(52) U.S. Cl. CPC B41J 2/04573; B41J 2/04585; B41J 2/04581; B41J 2/04536

(57) ABSTRACT

In the method for controlling actuators, corresponding actuators are controlled so that they eject the ink droplets for the print image. Corresponding actuators are additionally controlled in order to eject refresh droplets in the image background according to a random distribution. In the event that no image droplet is printed between two successive refresh droplets, the ink meniscus is set into vibration as a refresh measure between the refresh droplets.

### CROSS REFERENCE TO RELATED APPLICATIONS

This patent application claims priority to German Patent Application No. 10 2016 116195.0, filed Aug. 31, 2016, which is incorporated herein by reference in its entirety.

### BACKGROUND

The present disclosure relates to printing systems, including a method for controlling actuators of an ink printing system in a printing operation.

Ink printing systems may be used for single- or multicolor printing to a recording medium. The design of such an ink printing system is described in DE 10 2014 106 424 A1 and U.S. Pat. No. 9,302,474, for example. Such an ink printing system has at least one print group having at least one print bar per print color. The print bar is arranged transversal to the transport direction of the recording medium and has multiple print heads that possess a plurality of printing elements with nozzles in order to eject ink droplets from said nozzles. To print a line transversal to the printing direction, each nozzle is associated with a different image point of the line. In the longitudinal direction, the nozzles print the ink droplets onto the recording medium in chronological succession. The higher the print resolution, the more nozzles that are arranged in the print bars or the print head.

During the printing operation, the viscosity of the ink within a nozzle may not rise too much. With a rise in viscosity, there is the danger of the ink drying out, such that the nozzle at least temporarily clogs and therefore can no longer cleanly eject an ink droplet, and/or its desired ejection direction is altered due to blocking ink residues so that the droplets are printed at a pixel position or printing position that deviates from the nominal position.

A method for controlling vibration cycles in the printing operation can include an insertion of a vibration cycle between two ejected ink droplets in the event that no ink droplet has been ejected from a nozzle for a specific length of time during the printing operation. The information about the inactivity of nozzles can be determined from the print data that is supplied from the controller to the printer controller. During a vibration cycle, the actuator is activated with a predetermined waveform so that the ink meniscus at the exit of the nozzle is set in vibration but no ink is thereby ejected. Due to the vibration, the ink at the end of the nozzle channel is mixed so that ink with higher viscosity (having contact with the air outside of the ink channel) is mixed with fresh ink of lower viscosity inside the ink channel. Relative to a printing without vibration cycle, the viscosity thus does not increase as quickly, and the danger of a blockage of the nozzle beginning is reduced.

The danger of an increase in the viscosity of the ink can be reduced using refresh droplets that are printed in the image background during the printing operation insofar as a corresponding nozzle has not ejected ink droplets for a predetermined amount of time. In this example, the ink in the ink channel is renewed again, even given a longer period without ejection of an ink droplet, in that these refresh droplets are ejected. Fresh ink can thereby be resupplied from the ink reservoir to the print head. The danger of the ink drying up at the nozzle exit is likewise thereby reduced.

In the event that a print image having a small (e.g. very small) degree of areal coverage is printed (i.e. only very few ink droplets are ejected per side), most printing elements remain inactive, and the ink may thereby begin to dry as a result of increasing viscosity. In order to keep the viscosity within the predetermined limits, a large number of refresh droplets are ejected in the image background. However, that could unacceptably interfere with the image quality of the print image because the image background would become too strongly prominent.

It may also occur that the refresh droplets are printed too far apart, chronologically. A drying of the ink then might already start, which may lead to errors in the generation and ejection of the droplets. The refresh droplets thus might no longer be generated in a sufficient size since a restriction at the nozzle exit has already formed. The refresh droplets then would no longer entirely fulfill their actual function.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates an example ink print group.

FIG. 2 illustrates a printing element of an ink print group according to an exemplary embodiment of the present disclosure.

FIG. 3 illustrates a superposition of print image and refresh measurements according to an exemplary embodiment of the present disclosure.

FIG. 4 illustrates a chronological depiction of a print image with refresh measures according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

One or more exemplary embodiments provide a method for controlling actuators of an ink printing system via which the danger of the drying of ink at nozzle exits is reduced, and ink droplets are largely ejected from the nozzles with the desired size and the correct direction.

In an exemplary embodiment of the present disclosure, corresponding actuators of the printing elements are thereby controlled in order to eject ink droplets as image points onto the recording medium. The image points thereby correspond to the image data that ultimately lead to the printed image. Additionally, corresponding actuators of printing elements can be selected and controlled according to a random algorithm, independently of the image data, in order to eject refresh droplets onto the recording medium in the image background so that the ink in the nozzles that are not used for the print image is nevertheless still refreshed, and the danger of the ink drying out in the respective nozzles is reduced. Additionally, corresponding actuators are controlled in order to perform vibration cycles in which the ink meniscus at the output of the respective nozzle performs vibrates without an ink droplet being ejected. However, in an exemplary embodiment, the vibration cycle is only activated when no image droplet has been ejected by the same nozzle between the ejection of two successive refresh droplets.

In an exemplary embodiment, droplet sizes of refresh droplets and image droplets, or the total number of refresh droplets, can be advantageously adjusted depending on properties of the inks, the viscosity/drying behavior of the inks, the ink printing system, the print head geometry, and/or the environmental conditions.

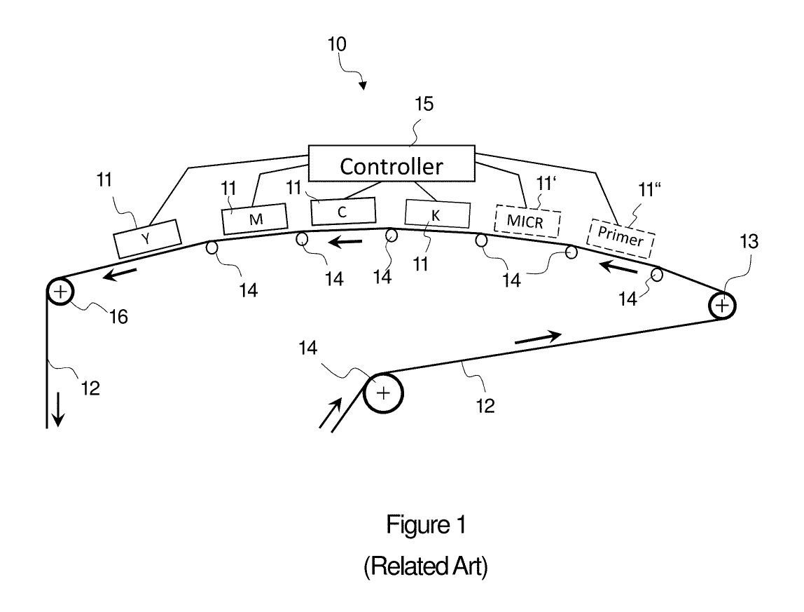

FIG. 1 illustrates an example print group 10 of an ink printing system. Example printing systems are also described in DE 10 2014 106 424 A1 and U.S. Pat. No. 9,302,474 B2, each of which is incorporated herein by reference in its entirety. A print group 10 can include at least one print bar 11 per color, having one or more print heads that are arranged transversal to the transport direction (represented by corresponding arrows in FIG. 1) of a recording medium 12. The recording medium 12 may thereby be printed to line by line with the desired fluids (inks/colors).

Four primary colors, such as YMCK (Yellow, Magenta, Cyan and Black=K) or RBG (Red, Blue, Yellow) and black (K), are typically necessary for a color printing, but or not limited thereto. Moreover, additional customer-specific colors or special inks such as Magnetic Ink Character Recognition (MICR) ink (e.g. magnetically readable ink) may be included and printed with a separate print bar 11′. It is likewise possible that transparent special fluids, such as primer or drying promoters, are likewise applied digitally with a separate print bar 11″, before or after the printing of the print image, in order to improve the print quality or the adhesion of the ink on the recording medium 12.

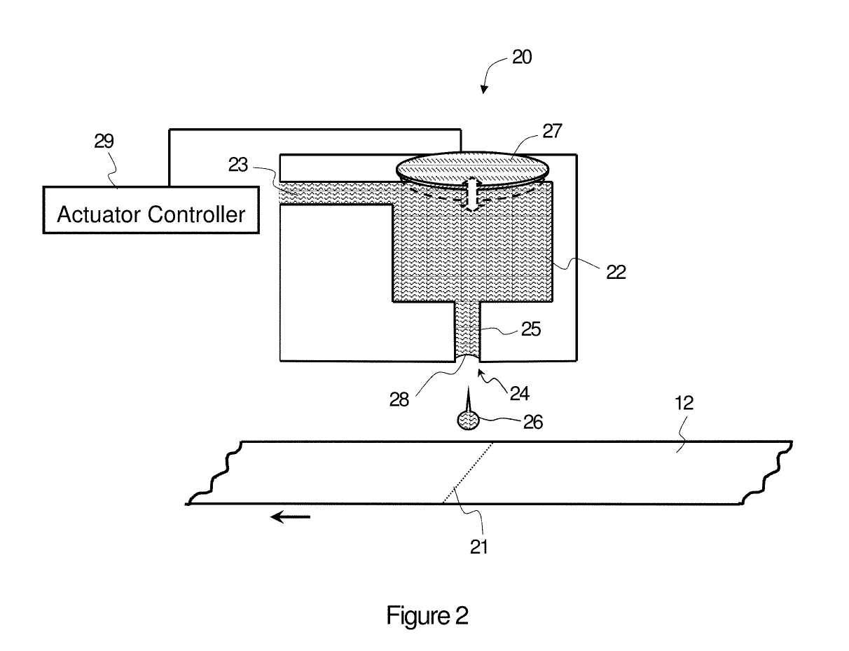

Each fluid/ink is printed with at least one print bar 11, 11′ or 11″. Line-width printing may thereby take place with a print bar 11. For each print position (also designated as an image point, pixel or dot) within a print line 21, at least one printing element 20 is provided (see FIG. 2). Depending on the desired resolution and print width, a corresponding number of printing elements 20 are then present for a print line 21. More than one print bar 11 may also be present per color in order to have a redundant printing element 20 in the event that the other should fail due to a clogged nozzle, or in the event that time-offset printing should take place with the redundantly present printing elements 20, for example in order to increase the print speed at the same resolution.

A web-shaped recording medium 12 is directed, via an infeed roller 13 and multiple deflection rollers 14, below the print bars 11 with the printing elements 20. Via a print head controller 15, the individual printing elements 20 are activated with a complex control signal corresponding to the desired image data in order to eject corresponding ink droplets 26 onto corresponding image positions of the recording medium 12. In an exemplary embodiment, the print head controller 15 includes processor circuitry that is configured to perform one or more functions and/or operations of the print head controller 15, such as generating one or more control signals to activate one or more printing elements 20.

The recording medium 12 is directed through the print group 10 with a predetermined and controllable web tension so that the individual ink droplets 26 may respectively be printed exactly at the desired image position on the recording medium 12 (this is also designated as being “in register”). With a take-up roller 16, the recording medium 12 is directed further to a drying (not shown) and possibly to a following print group in which the back side of the recording medium 12 may then be printed to.

FIG. 2 illustrates a single printing element 20 of a print head according to an exemplary embodiment of the present disclosure. In an exemplary embodiment, the printing element 20 has an ink chamber 22 that is filled or refilled with ink via an ink supply 23. A droplet 26 may be ejected via a nozzle 24 having a nozzle channel 25. An actuator 27 is arranged in the ink chamber 22 or in the nozzle channel 25 to generate a droplet 26. The actuator 27 is activated by the actuator controller 29 depending on the print data and ensures that the ink in the ink chamber 22 is placed under mechanical pressure, whereby ink is pressed out of the nozzle 24. In an exemplary embodiment, the actuator controller 29 includes processor circuitry that is configured to perform one or more functions and/or operations of the actuator controller 29, such as generating one or more control signals to activate the actuator 27 to control the operation of the actuator 27.

In an exemplary embodiment, if a piezoelement (e.g. piezoelectric element) is used as an actuator 27, the piezoelement expands (see double arrow and dashed line in FIG. 2) as soon as it is activated accordingly, and thereby places the ink under pressure so that the ink may “escape” (e.g. be ejected) via the nozzle 24. In the event that a thermal actuator (e.g. heating element) is used, a vapor bubble is generated in the nozzle channel 25 via heat (e.g. an explosion), and the vapor bubble presses (forces) an ink droplet 26 out of the nozzle 24 via its pressure.

In an exemplary embodiment, the control signal is a complex waveform that ensures that the actuator 27 momentarily expands and contracts again multiple times. Due to this changing application of negative pressure/positive pressure on the ink, that actuator 27 is set in oscillation, as a result of which droplets 26 may be pressed out of the nozzle 24. Depending on the waveform (e.g. frequencies, amplitudes, rise or fall times of the pulses, pulse-pause ratios given square wave pulses), the droplets 26 may be ejected from the nozzle 24 with different sizes or speed. Given smaller amplitude, higher frequency of the oscillations of the waveform, or very short pulses in comparison with longer pauses, only a vibration of the ink meniscus at the exit of the nozzle channel 25 may also be generated without an ink droplet 26 being released. The characteristic of the waveform is thus decisive for the formation of the droplet 26 or the vibration of an ink meniscus 28 at the exit of the nozzle channel 25.

In an exemplary embodiment, the waveform with which the actuator 27 is activated determines which size and/or shape of ink droplet 26 is produced. Depending on the characteristics, different ink droplet sizes may be ejected. Given high-speed printers with high print quality, droplets 26 having different volumes between, for example, 2 and 30 pl can be generated, depending on the print image. In an exemplary embodiment, the waveform may also be formed so that it can only set the ink meniscus 28 at the nozzle exit into vibration, without releasing a droplet 26. The ink in the nozzle channel 25 is thereby vibrated as well and mixes with fresh ink from the ink chamber 22. The viscosity of the ink at the nozzle exit is thereby reduced, such that the danger of a drying out at the nozzle exit is reduced. The ink at the nozzle exit is in contact with air, whereby the drying out and the increase of the viscosity in the ink channel are undesirably facilitated.

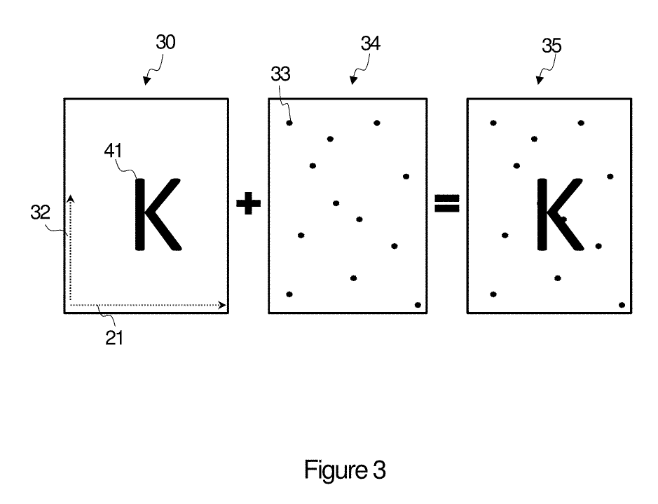

In an example printing operation, a print image 30 (see FIG. 3) can be printed corresponding to (e.g. based on) the image data. The print image 30 is thereby built up (created) line by line, and the respective printing elements 20 print to generate the entire print image 30. Ink droplets 26 are thereby ejected from these printing elements 20. The ink droplets 26 are applied onto the recording medium 12 as image points, or as parts of image points given a multilevel raster for greyscale values of an image point.

In a case where a complete print line 21 is always to be printed, all printing elements 20 could thus be arranged in one line. However, a high print resolution would then not be achievable due to the mechanical expansion of the printing element 20 since the printing elements 20 could not be arranged densely enough next to one another. In an exemplary embodiment, in order to achieve a high resolution, the nozzles 24 are arranged offset from one another in multiple nozzle rows on a surface (e.g. advantageously in a trapezoid shape) such that each image position along a print line 21 may be printed with a different nozzle element.

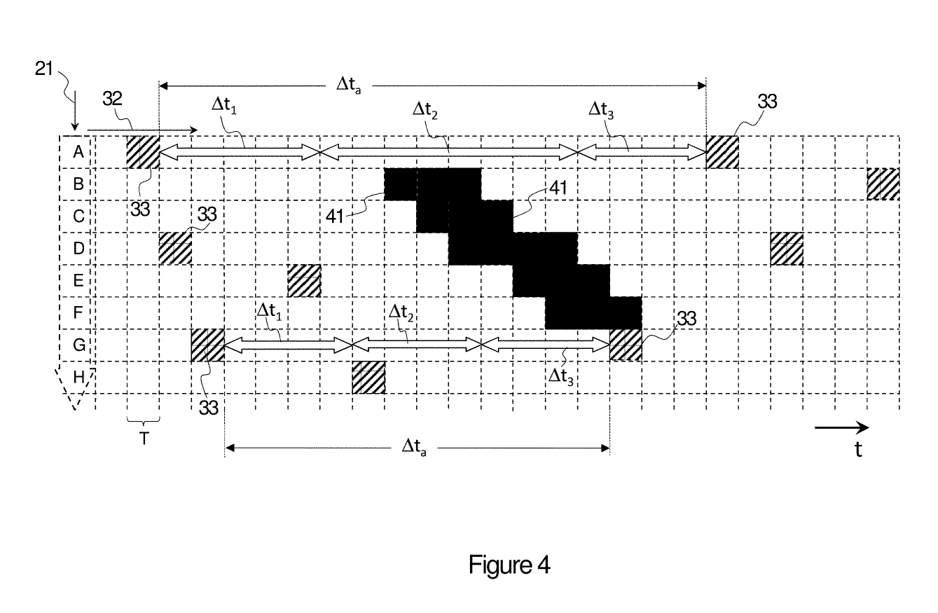

In an exemplary embodiment, an entire side of a printed image is assembled like a matrix comprising n print lines 21 and m columns 32 (see FIG. 4). Each column 32 is respectively printed by a different printing element 20. In a full-coverage printing, this occurs in one line clock, meaning that a printing element 20 may not print twice in one print line 21 but rather only prints at most a single time. For a page, this corresponds to a predetermined area on the recording medium 12 (for example the area of one side in the A4 format). A web-shaped recording medium 12 may be printed to with different page sizes. After printing, the web may be cut to size corresponding to the pages.

However, a print image 30 is not always printed to over its entire area; rather, it has a specific coverage density (i.e. a proportion of the surface that is covered by image points of a color). This is also designated as a degree of areal coverage. The degree of areal coverage expresses the ratio of the printed area relative to the total area, in a percentage. In documents with mostly text and graphics, the degree of areal coverage is typically approximately 5%. In such a case, many nozzles 24 are thus inactive most of the time.

In an exemplary embodiment, in FIG. 3, the letter “K” is shown as print image 30 that is printed on one side (e.g. of the recording medium 12). In this instance, in an exemplary embodiment, only those printing elements 20 are active whose column position corresponds to a print dot of the printed “K”. Therefore, only a small portion of the printing elements 20 are active and eject ink droplets 26 across multiple print lines 21. That is, only the printing elements 20 that form the lines of the “K” per print line 21 in the region of the printed “K”, and in the print line direction (characterized by the arrow 21), and accordingly in column length, the portion of the printing elements 20 is as many print lines 21 long as the print image 30 is high (corresponding to the number of print lines 21 for the vertical stroke of the “K”). In this example, most of the printing elements 20 are inactive, and thus eject no ink droplets 26 for the “K” or eject only during a few print lines 21 (such as is the case for the sloped lines of the “K”.

If no droplet 26 is ejected from a nozzle 24 for a specific length of time, the danger exists that the ink in this nozzle 24 dries up. Due to the contact with air, the viscosity of the ink increases (in contrast to the necessary fast drying of the ink on the recording medium 12). The ejection behavior of a droplet 26 changes with the increase of the viscosity, up to the point of possibly completely sealing the nozzle 24 with dried ink, which corresponds to a total failure of the nozzle 24. This becomes noticeable in the print quality. Total failure of a nozzle 24 is visible in the print image 30 as lighter stripes in an area that is otherwise printed over the entire area.

For this reason, in an exemplary embodiment, measures are can be taken that enable a cleaner printing of a print image 30. For example, a printing interruption for a print head maintenance is thus possible during which ink or cleaning fluid is then pressed through each nozzle 24 with subsequent cleaning of the nozzle plate in which the nozzles 24 are arranged. No printing operation occurs at this time.

However, a longer printing pause may arises due to this maintenance of the print heads, during which the printing system is not in printing operation and therefore may not work efficiently during the operation of the printer.

For this reason, in an exemplary embodiment, additional (or alternative) solution possibilities are provided during the printing operation that do not lead to a print interruption, while reducing the danger of the nozzles 24 drying up. In an exemplary embodiment, refresh droplets can be distributed/provided in the image background according to, for example, a random (or other) algorithm. In an exemplary embodiment, the printed refresh image points 33 qualitatively degrade the actual print image 30 as little as possible (e.g. interference with the visual impression of the print image 30 is reduced and/or minimized).

Therefore, both the size/volume of the refresh droplets and the total number of the refresh droplets may be set in advance per print side. However, in an exemplary embodiment, these variables can be set so that the actual print image 30 is not interfered with too much by the background image, meaning that the refresh image points 33 should interfere as little as possible. Nevertheless, a refresh droplet can still be ejected from specific nozzles 24 so that the ink there does not dry up.

In an exemplary embodiment, the positions of the refresh image points 33 on the recording medium 12, the total number of the refresh image points 33, and/or the droplet sizes or droplet volumes of the refresh droplets depend on various parameters, such as the condition of the ink, the design of the print group 10, the embodiment of the print heads, the environmental conditions (e.g. temperature and/or humidity), the downtime durations (e.g. duration/threshold of how long nozzles 24 do not print), and/or one or more other parameters as would be understood by one of ordinary skill in the relevant arts. For example, the viscosity behavior thus plays a decisive role together with the drying behavior of the ink. Configurations of the heads and the material used can also play an important role.

In an exemplary embodiment, as shown in FIG. 3, the ultimate print image 35 is comprised of a superposition of the actual print image 30 (composed of normal image points corresponding to the print data) and a refresh print image 34 with the refresh image points 33 that are printed with random distribution in the image background across the page. In an exemplary embodiment, the print image 30 is built up (i.e. printed) print line by print line 21 in lines in the column direction.

However, it may occur that two successive refresh droplets ejected with the same nozzle 24 are printed chronologically far apart from one another. During this long duration, it may occur that the ink in the nozzle channel 25 has already increased its viscosity so much that the second refresh droplet may no longer be ejected cleanly. The danger thereby exists that the refresh droplets no longer completely fulfill their actual function, and insufficient ink in the nozzle channel 25 is replaced by fresh ink or the mixing is too small.

For this reason, in an exemplary embodiment, a vibration cycle can be performed between two chronologically successive refresh droplets of the same nozzle 24. In this example, the actuator 27 is thereby activated such that the ink meniscus 28 at the nozzle exit is set into vibration instead of ejecting a droplet 26. Upon vibration, the surface of the ink at the nozzle exit alternatively deflects outward (convex) and inward (concave) in a rhythm determined by the waveform and the movement of the actuator 27. In an exemplary embodiment, such a vibration cycle can occur only when no normal image droplet 26 for an image point has been printed with the same nozzle 24 between the ejection points in time of the two refresh droplets, but is not limited thereto.

FIG. 4 illustrates the timing for a vibration cycle according to an exemplary embodiment. For the purpose of discussion, the timing is shown a simplified and over-dimensioned illustration. In an exemplary embodiment, the various printing elements A, B, C etc. that may print the columns 32 in the horizontal direction in chronological succession at the line clock are arranged in the direction of a print line 21. For example, for a new print line 21 for a column 32 (e.g. in every new print line 21 for each column 32), a droplet may thus be ejected or a vibration cycle may be performed. In an exemplary embodiment, a droplet can be ejected, and a vibration cycle can be performed, for a new print line 21 for a column 32. A refresh image point 33 is depicted with shading. With a vibration cycle, a print dot is not formed and therefore is not visible in FIG. 4. In this example, only the image points 33 and 31 that are printed on the recording medium 12 are shown. Only the time period at which the vibration cycle occurs is indicated in FIG. 4, which is described in the following.

If a normal ink droplet is not printed (leading to the image point 41, and as is the case in columns A and G) during the duration between the ejection of two successive refresh droplets (corresponding to the time interval Δtₐ between two successive refresh image points 33), a vibration cycle is inserted between them at a predetermined point in time. In an exemplary embodiment, a vibration of the ink meniscus 28 occurs in the middle period (time interval Δt₂) between the two refresh image points 33. After the first refresh image point 33 in column A, a first waiting time period (time interval Δt₁) passes, and a second waiting time period (time interval Δt₃) passes before the following next refresh image point 33, during which no activation of the actuator 27 of the printing element 20 occurs for column 32 A (during the second waiting time period, the ink in the nozzle 24 may rest so that the actuator 27 re-targets ink again and can place it under pressure under the same conditions). In an exemplary embodiment, since no normal image point 41 is situated between the two refresh image points 33, a vibration cycle 33 can occur in the middle time interval Δt₂ between the two refresh image points 33.). In an exemplary embodiment, the duration of the vibration cycle is at least the duration of a single print line 21 (i.e. the time interval of the line pitch T). Given a resolution of 600×600 dpi, a line pitch T of approximately 42 μm results. Given a transport velocity of 1 m/s, this corresponds to a duration of approximately 42 μs. Given a print width of 20 inches, 12000 columns are present (with the same number of printing elements 20/nozzles 24).

A vibration cycle similarly occurs between the two refresh image points 33, in column G. No vibration cycle occurs in columns B through F since multiple normal image points 41 are respectively situated between the successive refresh image points 33. In this example, the associated printing element 20 are active to print image points 41, thereby causing the ink in the nozzle channels to be refreshed by the ejection of image droplets and refilling of a corresponding quantity of fresh ink in the ink chamber 22. Thus, no refresh measure is necessary there. Only a single refresh image point 33 is randomly shown in column H, such that for the further process, it is still open as to whether a refresh image point 33 or a normal image point 41 is printed next.

In an exemplary embodiment, a corresponding actuator 27 of a printing element 20 is controlled such that the actuator:
ejects ink droplets 26 based on corresponding print data;
may eject a refresh droplet selected according to a random algorithm, independently of the print data, in order to renew ink in the nozzle channel 25; and
may implement a vibration cycle in which vibrations of the ink meniscus 28 are performed at the nozzle exit without an ink droplet 26 being ejected.

However, in an exemplary embodiment, the ejection of an ink droplet depends on the print image 30. In an exemplary embodiment, the ejection of a refresh droplet depends solely on the random algorithm. In an exemplary embodiment, the random algorithm is configured such that the refresh droplets 26 are not situated too far from one another (e.g. advantageously below a threshold at which, if it is exceeded, an increased viscosity may lead to ejection problems of a droplet). In an exemplary embodiment, the implementation of the vibration cycle depends on whether an ink droplet 26 for the print image 30 has been ejected or not between two successive refresh droplets.

In an exemplary embodiment, the vibration cycle is chronologically situated between the points in time of the ejection of successive refresh droplets. The vibration cycle thereby occurs within the time interval Δt₂, which occurs only after a first wait time period in which no noticeable viscosity increase occurs, begins after the ejection of the first refresh droplet, and ends before a second wait time period before the ejection of the next refresh droplet. In an exemplary embodiment, the point in time typically occurs in the middle between the two points in time of the ejection of the two refresh droplets. The time interval Δtₐ between two successive refresh droplets is preferably divided up into approximately three equally long time intervals Δt₁ through Δt₃ (as shown in column G). The vibration cycle then occurs within the middle third (time interval Δt₂). The ink in the corresponding nozzle 24 thus does not remain unmixed for too long, and the viscosity does not increase too quickly, such that the ejection properties of the next refresh droplet can optimally barely change. In an exemplary embodiment, given an optimally set random algorithm, a single vibration cycle can occur within the time interval Δtₐ. In an exemplary embodiment, given a critical ink that tends to dry up especially quickly, two or more vibration cycles could also occur between the two refresh droplets, or a vibration cycle that is applied for longer than one line interval could be implemented.

In an exemplary embodiment, location and length of the time interval Δt₂ for the vibration cycle between the ejection of two successive refresh droplets may be dependent on: parameters and/or properties of the ink used; parameters and/or properties of the printing system used; and/or one or more environmental conditions.

In an exemplary embodiment, the droplet sizes and/or droplet volumes of the refresh droplets may be selected depending on the time interval of the ejection of two successive refresh droplets. The refresh droplets may thus be chosen to be larger if the time between the preceding refresh droplet and the refresh droplet that is now to be printed is too long, such that the danger would exist that the ink's viscosity would increase too greatly.

In an exemplary embodiment, the droplet size for the refresh droplets may be fixed in advance by the operator of the ink printing system. In an exemplary embodiment, the total number of refresh droplets may likewise be fixed in advance per print page. Depending on the printing application or print job, more or fewer refresh droplets may be accepted in the print image 30. Given a high-grade printing, normally only a few refresh droplets and/or smaller refresh droplets are accepted in comparison to a printing in which the requirements for the image quality are lower. More specks in the image background make less of a difference there.

In an exemplary embodiment, the droplet size for the refresh droplets may also be dependent on the droplet sizes of the ink droplets 26 for the image points 41. In an exemplary embodiment, if the droplet sizes for the image points 41 are already small, the droplet sizes for the refresh droplets can also be small so that they are not perceived too acutely.

A vibration cycle may also be referred to as a prefire. In a vibration cycle (prefire), only the ink meniscus 28 is thereby set into vibration, whereby ink in the nozzle channel 25 is mixed in order to slow the ink drying up. A fast movement of the surface of the ink at the nozzle exit already also leads to a viscosity reduction due to said fast movement. The meniscus vibration leads to the situation that ink is mixed and the next refresh droplets may be printed with approximately identical quality and size. It is prevented that different sizes of refresh droplets are printed, and these are also printed at the correct positions for which they are provided. In the event that ink at the nozzle exit is partially dried up, an ink droplet 26 is no longer ejected in its desired direction but rather somewhat obliquely, such that an unwanted print image 30 (such as streakiness) may be created. In an exemplary embodiment, in the vibration cycle, the actuator 27 is activated with a predetermined waveform such that the surface of the ink at the ink exit is set into vibration but no droplet is ejected.

In an exemplary embodiment, refresh droplets are typically used very conservatively in the image background. The image background may typically be comprised of, for example, approximately 0.3% refresh droplets (degree of areal coverage; relative to the possible image area of a page), but is not limited thereto. With a vibration cycle between two successive refresh droplets, it may be achieved that markedly fewer refresh droplets are necessary (for example, only 0.06% refresh droplets must be printed in the background), and nevertheless the print quality remains approximately the same in comparison to the previous degree of coverage of refresh image points 33, of 0.3%. In an exemplary embodiment, since the menisci are still set into vibration, the quality (size, volume or ejection direction) of the refresh droplet remains largely the same. Without vibrations, the quality would degrade. In contrast to the ejection of refresh droplets, ink is saved via the vibration cycle.

In an exemplary embodiment, the droplet size that is intended by the waveform thereby remains largely unchanged since the ink is largely conserved in terms of its viscosity via the vibration cycle. The distribution of the refresh droplets in the background is likewise defined and is established by a random algorithm depending on various parameters and properties of the ink that is used, print heads, environmental conditions etc., and this independently of the actual print image 30. Print image 30 and refresh image point 34 are thus superimposed and printed independently of one another. In the event that an image droplet and a refresh droplet should be ejected simultaneously by a printing element 20, only the image droplet is generated since the actual print image 30 has priority.

Exemplary embodiments can use an ink printing system having piezo-actuators configured to eject ink droplets 26. However, exemplary embodiments of the present disclosure can be implemented in an ink printing system configured to thermally generate the ink droplet 26 (with heating element or laser) in that, as a result of the action of heat, an air bubble is generated that then presses an ink droplet 26 out of the nozzle 24.

One or more exemplary embodiments of the present disclosure can be implemented in an ink printing system that is configured to operate with a web-shaped recording medium 12. If, given a web-shaped recording medium 12, a page is discussed, this corresponds to the desired page of the print job which, for example, could correspond to, for example, the A5 format.

Embodiments can be implemented with page-shaped or sheet-shaped recording medium. The present disclosure is not restricted by the type or material of the recording medium 12. For example, paper, paperboard, plastic films, metal foils, mixed materials, and/or one or more other medium types can be used as would be understood by one of ordinary skill in the relevant arts.

In an exemplary embodiment, the ink printing system may have two print groups 10, wherein the front side is printed to in the first print group 10 and the back side is printed to in the second print group 10 (in the event that duplex printing is desired). After the print group 10, a drying of the ink on the recording medium 12 with subsequent cooling is provided so that the recording medium 12 may be supplied to the second print group 10 under the same conditions or also may be processed accordingly (cutting, scoring, folding, stacking etc.) in a post-processing without liquid ink or damp ink being smeared, and the print image 30 thus being damaged.

In an exemplary embodiment, during the printing operation, meniscus vibrations and/or the printing of refresh droplets are used as refresh measures. In an exemplary embodiment, the refresh droplets are ejected independently of the print image 30 (i.e. independently of the print data). In an exemplary embodiment, using the print data, the print controller is configured such that it knows when and at what positions droplets 26 for the print image 30 are ejected (also broadly predictively across multiple pages).

In an exemplary embodiment, upon both ejection of a droplet 26 for the print image 30 and ejection of a refresh droplet, just as much ink as was ejected is refilled into the ink chamber 22. The ink is thus refreshed. However, the normal printing of the print image 30 is not a refresh measure in the sense of refresh droplets or vibration cycles, even if the ink in the ink chamber 22 is thereby still refilled with fresh ink.

In an exemplary embodiment, the refresh droplets may also take into account the print image 30, and a refresh droplet may then only be printed if a nozzle 24 has not ejected a droplet 26 (be it refresh droplet or image droplet) for a longer amount of time. The information about the ejection points in time is included in the print data and is used by the printer controller in order to be able to accordingly, predictively implement refresh droplets and vibration cycles.

### Conclusion

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, “processor circuitry” can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

10 print group
11 print bar
12 recording medium
13 supply roller
14 deflection roller
15 print head controller
16 take-up roller
20 printing element
21 print line
22 ink chamber
23 ink supply
24 nozzle
25 nozzle channel
26 ink droplet
27 actuator
28 ink meniscus
29 actuator controller
30 print image
32 column
33 refresh image point
34 refresh print image
35 ultimate print image
41 image point
T line pitch
Δtₐ time interval between two refresh droplets
Δtₙ time interval

What is claimed is:

1. A method to control actuators of an ink printing system in a printing operation, the ink printing system including at least one print group having at least one print bar per print color, a print bar having at least one print head having a plurality of printing elements respectively having a nozzle that are respectively controlled by an associated actuator to eject ink droplets via the respective nozzles, the printing elements being arranged so that, across an entire print width, a respective ink droplet may be printed along a print line, transversal to the transport direction of a recording medium, the method comprising:
controlling corresponding actuators to eject ink droplets as image points onto the recording medium, wherein the positions of the image points correspond to the desired image data;
controlling one or more of the actuators, selected according to a random algorithm, to eject refresh droplets onto the recording medium independently of the image data; and
controlling one or more of the actuators to perform a vibration cycle, whereby vibrations of the ink meniscus at a nozzle exit associated with the one or more actuators are performed without an ink droplet being ejected, in the event that the one or more actuators is not activated to eject image droplets between the ejection of two successive refresh droplets.

2. The method according to claim 1, wherein:
the vibration cycle is performed in a time interval between the ejection of the two successive refresh droplets; and
the vibration cycle occurs chronologically within a time interval that begins after a first predetermined wait time period after the ejection of a first of the two successive refresh droplets and ends before a second predetermined wait time period before the ejection of a second of the two successive refresh droplets.

3. The method according to claim 1, wherein a droplet size or droplet volume is selected based on a time interval of the ejection of a first of the two successive refresh droplets.

4. The method according to claim 1, characterized in that a droplet size or droplet volume for the refresh droplet is set beforehand.

5. The method according to claim 1, wherein a total number of the refresh droplets is set beforehand per print page.

6. The method according to claim 1, wherein positions of refresh image points at which refresh droplets are printed onto the recording medium, according to a random algorithm, are set beforehand per print page and independently of the print image.

7. The method according to claim 1, wherein a droplet size or droplet volume for the refresh droplets is selected based on the droplet size or droplet volume of the ink droplets for the image points.

8. The method according to claim 1, wherein a time interval between the ejection of two of the refresh droplets is based on:
properties of ink that is used by the printing system;
properties of the printing system; and/or
one or more environmental conditions.

9. The method according to claim 1, wherein location and length of a time interval for the vibration cycle between the ejection of two successive refresh droplets is determined based on:
parameters and properties of ink used;
parameters and properties of the printing system; and/or
one or more environmental conditions.

10. A non-transitory computer-readable storage medium with an executable program stored thereon, wherein, when executed, the program instructs a processor to perform the method of claim 1.

11. A printing system comprising:
a plurality of actuators of a print head; and
a controller that is configured to control one or more of the plurality of actuators to:
eject ink droplets as image points onto a recording medium based on image data;
eject refresh droplets onto the recording medium independently of the image data;
perform a vibration cycle based on an activation of plurality of actuators to the eject ink droplet between successive ejections of the refresh droplets.

12. The printing system according to claim 11, wherein the controller is configured to control the one or more of the plurality of actuators to perform the vibration cycle if the one or more of the plurality of actuators is not activated to eject ink droplets between ejection of two successive refresh droplets.

13. The printing system according to claim 11, wherein the one or more actuators of the plurality of actuators to eject the refresh droplets are selected based on a random algorithm.

14. The printing system according to claim 11, wherein the one or more actuators of the plurality of actuators to eject the refresh droplets are selected randomly.

15. The printing system according to claim 11, wherein the vibration cycle comprises activating one of more of the plurality of actuators to vibrate an ink meniscus at a nozzle exit associated the one or more of the plurality of actuators without ejecting an ink droplet from the nozzle exit.
